(19) United States
(12) Patent Application Publication
(10) Pub. No.: US 2012/0125173 A1
(43) Pub. Date: May 24, 2012

(54) FOLDABLE SCORING BASE WITH AN INTEGRATED MEDIA TRIMMER

(75) Inventors: Daniel A. Nelson, Bountiful, UT (US); George McEwan, Centerville, UT (US)

(73) Assignee: MAKING MEMORIES WHOLESALE, INC., North Salt Lake, UT (US)

(21) Appl. No.: 13/109,758

(22) Filed: May 17, 2011

Related U.S. Application Data
(60) Provisional application No. 61/345,971, filed on May 18, 2010.

(51) Int. Cl. B26D 3/08; B26D 7/01

(52) U.S. Cl. 83/886; 83/879

(57) ABSTRACT

A scoring base with an integrated media trimmer may be utilized to cut and/or score various types of media. The base may comprise an upper portion and a lower portion connected via a hinge. The lower portion may be configured to rotate with respect to the upper portion from a folded position to an unfolded position. A scoring implement, such as a bone folder, may be used to score a medium by tracing scoring grooves formed in the base. Additionally, the scoring base may include an integrated media trimmer comprising a cutting arm, a blade holder, and a cutting blade. The cutting arm may pivot from a cutting position to a storage position. The cutting arm may be configured to secure a bone folder within a depression during storage.

### RELATED APPLICATIONS

This application claims the benefit of U.S. Provisional Patent Application No. 61/345,971 filed on May 18, 2010, titled “CUTTING TOOL,” the entirety of which is incorporated herein by reference.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates one embodiment of a foldable scoring base with an integrated media trimmer in a cutting position.

FIG. 2 illustrates one embodiment of a foldable scoring base with an integrated media trimmer in a disengaged position prior to pivoting.

FIG. 3 illustrates one embodiment of a foldable scoring base with an integrated media trimmer rotated between a cutting position and a storage position.

FIG. 4 illustrates one embodiment of a foldable scoring base with an integrated media trimmer in a storage position.

FIG. 5 illustrates one embodiment of a foldable scoring base with a lower scoring board folded with respect to an upper scoring board.

FIG. 6 illustrates one embodiment of a support lattice for a foldable scoring base with an integrated media trimmer.

FIG. 7A illustrates one embodiment of an envelope guide storage slot positioned in the lower scoring board of a foldable scoring base.

FIG. 7B illustrates one embodiment of an envelope guide storage slot within the support lattice of a foldable scoring base.

FIG. 8A depicts a top view of a media trimmer including a cutting arm and a blade holder, according to one embodiment.

FIG. 8B depicts a side view of a media trimmer including a cutting arm and a blade holder, according to one embodiment.

FIG. 8C depicts a bottom view of a media trimmer including a cutting arm and a blade holder securing a fixed-blade, according to one embodiment.

FIG. 9 illustrates one embodiment of a foldable scoring base, including a bone folder depression and an envelope guide storage slot.

FIG. 10A illustrates one embodiment of a rosette strip having a plurality of scored grooves that may be created using a foldable scoring base.

FIG. 10B illustrates the scored rosette strip of FIG. 10A folded along the scored grooves to form an accordion configuration.

FIG. 10C illustrates the folded and scored rosette strip of FIG. 10B with a first end partially encircled towards a second end.

FIG. 11 illustrates a set of scored rosette strips of varying sizes having different scoring patterns.

In the following description, numerous specific details are provided for a thorough understanding of the various embodiments disclosed herein. The systems and methods disclosed herein can be practiced without one or more of the specific details, or with other methods, components, materials, etc. In addition, in some cases, well-known structures, materials, or operations may not be shown or described in detail in order to avoid obscuring aspects of the disclosure. Furthermore, the described features, structures, or characteristics may be combined in any suitable manner in one or more alternative embodiments.

### DETAILED DESCRIPTION

This disclosure describes various embodiments of a foldable scoring base with an integrated media trimmer. According to various embodiments, a scoring base comprises an upper scoring board and a lower scoring board connected via a pivot member. The lower scoring board may be configured to rotate with respect to the upper scoring board from an unfolded position to a folded position. The pivot member may include one or more hinges, riveted brackets, and/or alternative pivotable fasteners.

According to various embodiments, the scoring base includes a section of lineal scoring grooves configured to facilitate the scoring of various media. A scoring implement, such as a bone folder, may be used to score a medium. For example, the point of the scoring implement may be traced along a lineal scoring groove formed in the scoring base in order to score a medium placed on the scoring base. The lineal scoring grooves on the lower scoring board may be aligned with respect to the lineal scoring grooves on the upper scoring board when the lower scoring board is in an unfolded position. According to one embodiment, the lineal scoring grooves of the upper and lower scoring board are aligned perpendicular to a parting line dividing the upper and lower scoring boards. According to an alternative embodiment, the lineal scoring grooves of the upper and lower scoring boards may be aligned with respect to one another and parallel to the parting line dividing the upper and lower scoring boards.

According to various embodiments, one of the upper scoring board and the lower scoring board may include a storage slot configured to receive an envelope guide. Additionally, the upper scoring board may include a depression configured to receive a scoring implement, such as a bone folder. According to various alternative embodiments, the scoring base may include one or more additional pockets, depressions, or other features configured to receive and/or store additional implements or tools. For example, the scoring base may include a slot configured to receive a ruler, clamp, magnet, blade sharpener, extra blade, and/or scissors.

The underside of the scoring base may include legs, magnets, levers, clamps, suction cups, and/or other support mechanisms to support the scoring base. The top face of the lower scoring board may include permanent or removable feet configured to support the scoring base while the lower scoring board is in a folded position. The scoring base may also include or be constructed of ferromagnetic materials in order to facilitate the use of magnetic clamps and/or ruler for aligning and/or securing media relative to the scoring base.

A catch or latch may be configured to selectively secure the lower scoring board in a folded position with respect to the upper scoring board. For example, a magnetic latch may comprise a magnet fitted to the underside of the lower scoring board and a complementary ferromagnetic material fitted to the underside of the upper scoring board.

According to various embodiments, the scoring base includes an integrated media trimmer comprising a cutting arm, a blade holder, and a cutting blade. The blade holder may be slidably coupled to the cutting arm and configured to secure a rotary blade or a fixed-blade. According to various embodiments, the media trimmer may be configured to cut any of a wide variety of media, such as paper, cloth, corkboard, leather, plastics, metal, foil, canvas, cardstock, cardboard, acetate, drafting film, illustration board, black core artist mat board, laminates, and/or tissue paper. According to an alternative embodiment, the media trimmer may comprise a cutting arm configured as a guillotine-style cutting blade.

A top end of the cutting arm may be pivotably secured to the upper scoring board and configured to rotate from a cutting position, in which a bottom end of the cutting arm is coupled to the lower scoring board, to a storage position, in which the bottom end of the cutting arm is coupled to the upper scoring board. Moreover, according to various embodiments, the cutting arm may be configured to secure a scoring implement within the previously described depression when the cutting arm is rotated to the storage position.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment.

As used herein, the term “media” signifies any type of material that may be trimmed, cut, scored, marked, folded, embossed, and or creased. Types of media include, but are not limited to, paper, cloth, corkboard, leather, plastics, metal, foil, canvas, cardstock, cardboard, acetate, drafting film, illustration board, black core artist mat board, laminates, and tissue paper.

In some cases, well-known features, structures or operations are not shown or described in detail. Furthermore, the described features, structures, or operations may be combined in any suitable manner in one or more embodiments. The embodiments of the disclosure will be best understood by reference to the drawings, wherein like parts are designated by like numerals throughout. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments.

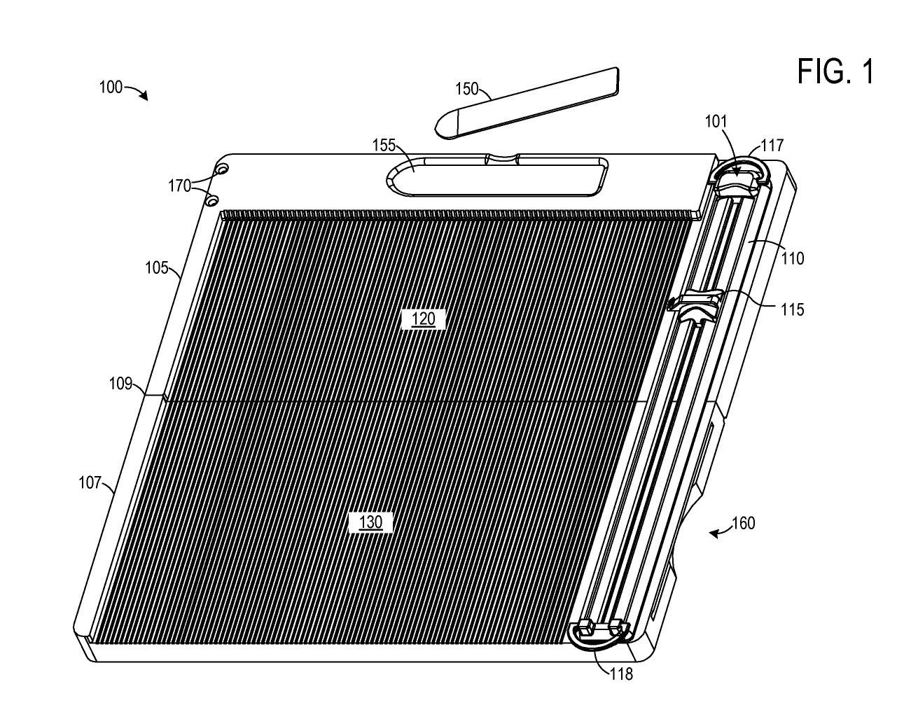

FIG. 1 illustrates an exemplary embodiment of a foldable scoring base 100 with an integrated media trimmer 101 in a cutting position. As illustrated, foldable scoring base 100 includes an upper scoring board 105 and a lower scoring board 107. According to various embodiments, scoring base 100 may be embossed, debossed, or silk-screen printed with various measurement markings in order to facilitate accurate media scoring and cutting. For example, a graduated scale may be silk screened on scoring base 100.

Lower scoring board 107 may be rotatably coupled to upper scoring board 105 via one or more pivot members, such as a hinge or pivotable fastener. An elongated hinge may remain hidden beneath parting line 109 while lower scoring board 107 is in an unfolded position, as illustrated. According to various embodiments, there is a minimal or non-existent gap between lower scoring board 107 and upper scoring board 105 at parting line 109.

As illustrated, upper scoring board 105 and lower scoring board 107 may each include a section of lineal scoring grooves 120 and 130 aligned with respect to one another and perpendicular with respect to parting line 109. Lineal scoring grooves 120 and 130 may be spaced at equal distances or in any of a variety of patterns. Additionally, each of the grooves may be the same depth and/or width or, alternatively, the grooves may be arranged according to a pattern and may include grooves of various widths and/or depths.

According to one embodiment, each groove may be spaced in intervals of some fraction of an inch or a specified number of millimeters. Lineal scoring grooves 120 and 130 may provide a guide for a user to trace a scoring implement, such as bone folder 150, in order to score, fold, and/or create a crease in a medium placed on scoring base 100.

Throughout the drawings, lineal scoring grooves 120 and 130 are illustrated as perpendicular with respect to parting line 109; however, according to one alternative embodiment, lineal scoring grooves 120 and 130 may be aligned with respect to one another and parallel to parting line 109. According to such an embodiment, the two sections of lineal scoring grooves 120 and 130 may be aligned such that parting line 109 does not disrupt the spacing and/or pattern of the grooves.

Media trimmer 101 may include a cutting arm 110, a blade holder 115, an upper ring 117 near the top end of cutting arm 110, and a lower ring 118 near the bottom end of cutting arm 110. According to various embodiments, the top end of cutting arm 110 may be rotatably secured to upper scoring board 105. The bottom end of cutting arm 110 may be selectively coupled to lower scoring board 107 in a cutting position, as illustrated. According to various embodiments, the bottom end of cutting arm 110 may be pivoted with respect to the top end of cutting arm 110 and moved from the cutting position to a storage position. In the storage position, the bottom end of cutting arm 110 may selectively engage depressions 170 on upper scoring board 105.

According to the illustrated embodiment, blade holder 115 is slidably coupled to cutting arm 110 and may be configured to secure a fixed-blade and/or a rotary blade. The blade may be sharpened as it is used to extend the useable life of the blade. Alternatively, cutting arm 110 may be configured as a guillotine-style blade configured to pivot up and down with respect to the plane of scoring base 100 in order to cut media. According to various embodiments, media trimmer 101 may be configured to cut, score, and/or trim any of a wide variety of media, including paper, cloth, corkboard, leather, plastics, metal, foil, canvas, cardstock, cardboard, acetate, drafting film, illustration board, black core artist mat board, laminates, and/or tissue paper.

Additionally, upper scoring board 105 may include a depression 155 configured to receive a scoring implement, such as bone folder 150. According to one embodiment, bone folder 150 may snap securely into depression 155. According to another embodiment, bone folder 150 may be secured within depression 155 by positioning cutting arm 110 in the storage position, as is discussed in greater detail below.

Lower scoring board 107 may include one or more storage slots 160. According to various embodiments, storage slot 160 may be configured to receive any of a wide variety of tools, such as an envelope guide, a ruler, clamp, magnet, blade sharpener, extra blade, and/or scissors. According to the illustrated embodiments, storage slot 160 is configured to secure a triangular envelope guide; however, the shape and size of storage slot 160 may be modified to accommodate alternative tools. Alternatively or additionally, upper scoring board 105 may include a storage slot.

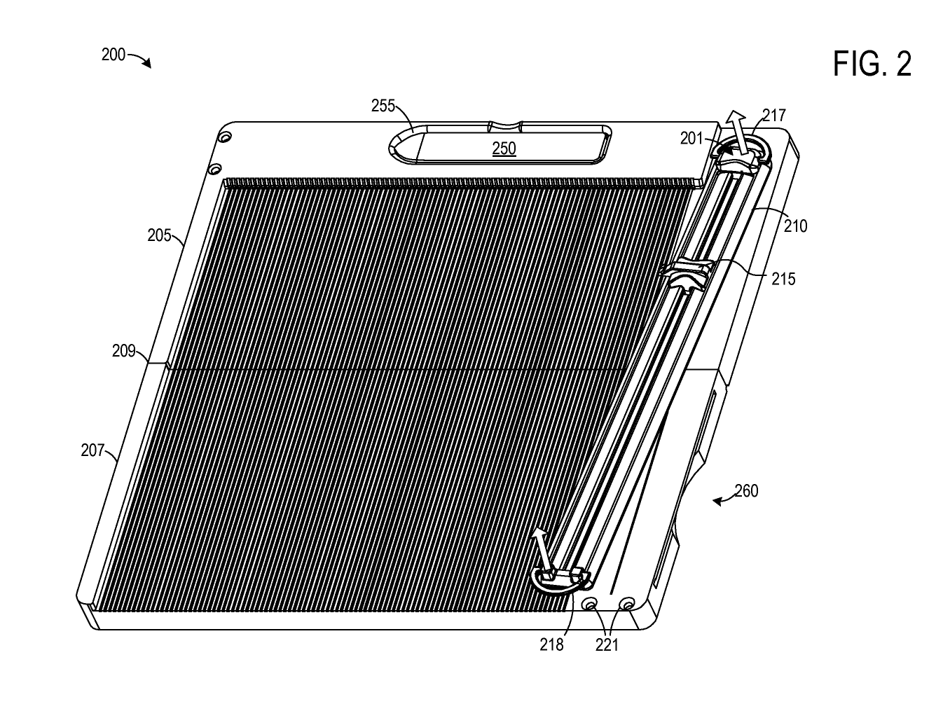

FIG. 2 illustrates an exemplary embodiment of a foldable scoring base 200 with an integrated media trimmer 201 in an unlocked and disengaged position. Prior to pivoting media trimmer 201 from a cutting position to a storage position, bone folder 250 may be placed within depression 255 and an envelope guide may be stored within storage slot 260. As previously described, media trimmer 201 may include a cutting arm 210, a blade holder 215, an upper ring 217 located near the top end of cutting arm 210, and a lower ring 218 near the bottom end of cutting arm 210.

According to various embodiments, the top end of cutting arm 210 may be rotatably secured to upper scoring board 205 via a spring loaded locking pin and ring assembly. The locking pin and ring may allow cutting arm 210 to rotate about a pivot point without detaching from upper scoring board 205. A spring may provide a downward force on cutting arm 210 in order to engage bosses located on the underside of cutting arm 210 at the top and bottom ends with depressions 221 located on lower scoring board 207 and depressions (not visible in FIG. 2) located on upper scoring board 205.

Cutting arm 210 may be unlocked and free to pivot about the pin and ring assembly by pulling up on upper ring 217 and lower ring 218. FIG. 2 illustrates cutting arm 210 elevated slightly in an unlocked and disengaged position prior to rotation about its pivot point. Further discussion of the locking pin and ring assembly are provided below in conjunction with FIG. 6.

According to an alternative embodiment, cutting arm 210 may be fixed along the top edge of upper scoring board 205. That is, cutting arm 210 may be fixed along the edge of upper scoring board 205 that is opposite parting line 209. According to such alternative embodiments, cutting arm 210 may not be configured to pivot from a cutting position to a storage position. Scoring base 200 may also be adapted to allow for media to be cut, scored, and/or trimmed by media trimmer 201 in the fixed position.

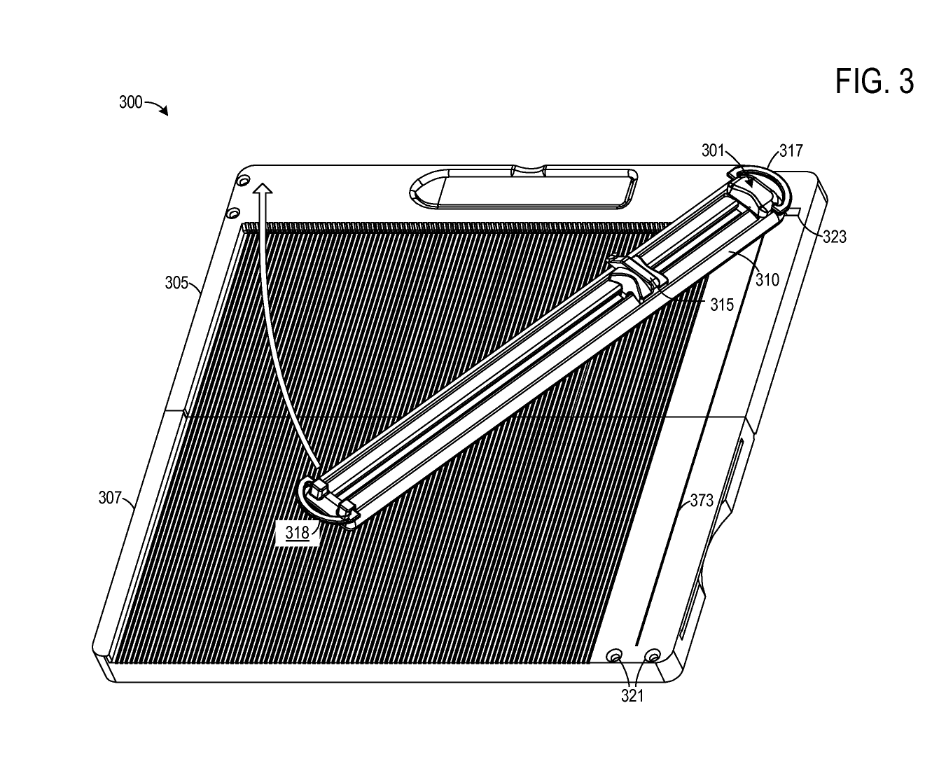

FIG. 3 illustrates an exemplary embodiment of a foldable scoring base 300 with an integrated media trimmer 301 rotated between a cutting position and a storage position. As previously described, cutting arm 310 may be unlocked by raising cutting arm 310 with respect to scoring base 300. An operator may grasp upper ring 317 and/or lower ring 318 in order to raise cutting arm 310. Once raised, bosses located on the underside of cutting arm 310 are disengaged from depressions 321 in lower scoring board 307 and depressions 323 in upper scoring board 305. Cutting arm 310 may be pivoted with respect to the pin and ring assembly securing the top end of cutting arm 310 to upper scoring board 305. FIG. 3 provides an illustration of cutting arm 310 half way between a cutting position and a storage position.

FIG. 3 also illustrates a blade guide 373 configured to receive a blade secured by blade holder 315. According to various embodiments, blade guide 373 spans upper scoring board 305 and lower scoring board 307 and is aligned when lower scoring board 307 is in an unfolded position. Blade guide 373 may also facilitate the sharpening of a blade secured by blade holder 315. According to various alternative embodiments, blade guide 373 and the portion of scoring base 300 to the right of it may be adapted to suit the style of blade and/or cutting arm utilized. For example, if cutting arm 310 is alternatively configured as a guillotine-style trimmer, then blade guide 373 may be configured as the furthest right edge and may be formed of metal.

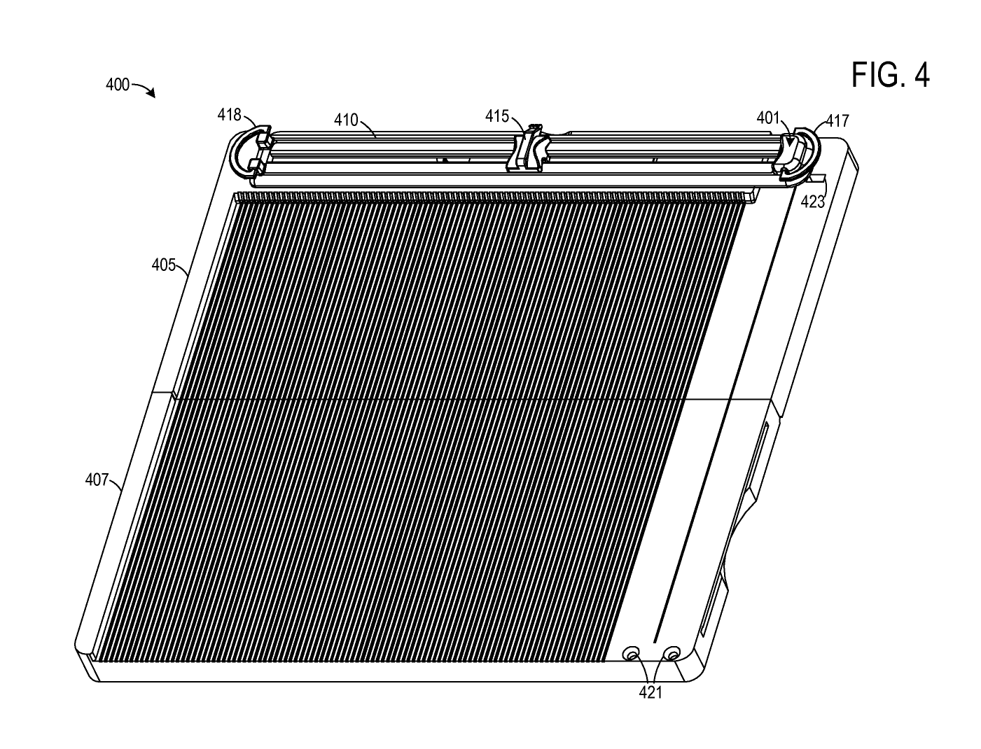

FIG. 4 illustrates an exemplary embodiment of a foldable scoring base 400 with an integrated media trimmer 401 in a storage position. As illustrated, the bottom end of cutting arm 410, near lower ring 418, is secured to upper scoring board 405. With media trimmer 401 in a storage position, cutting arm 410 may extend across a depression configured to receive a bone folder and secure the bone folder within the depression.

As previously described, cutting arm 410 may include a blade holder 415 and upper ring 417 and lower ring 418. With cutting arm 410 pivoted to a storage position, depressions 423 in upper scoring board 405 and depressions 421 in lower scoring board 407 may be visible.

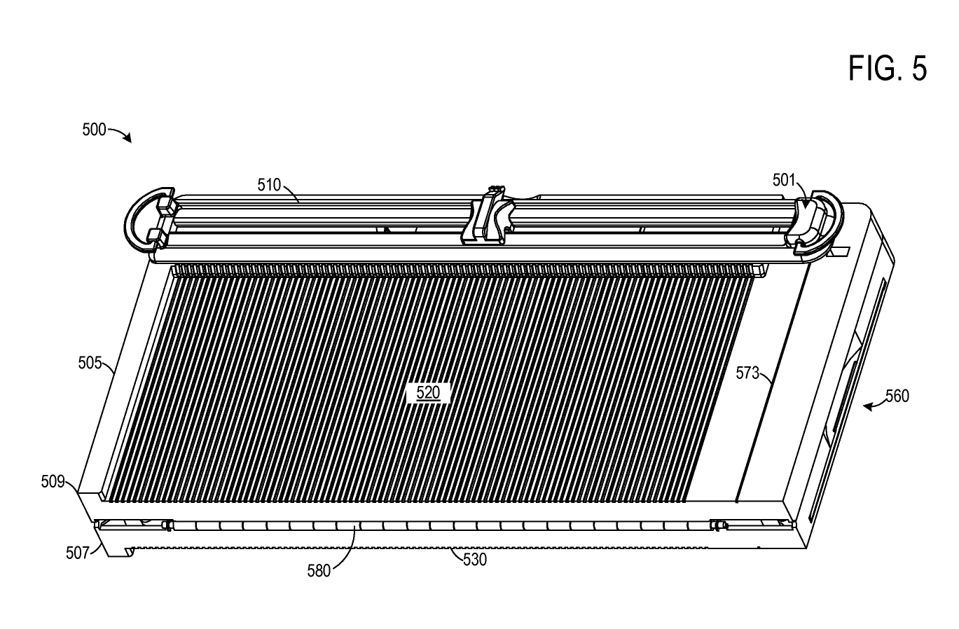

FIG. 5 illustrates an exemplary embodiment of a foldable scoring base 500 with a lower scoring board 507 folded with respect to an upper scoring board 505. As illustrated, a hinge 580 may be located beneath parting line 509. According to various embodiments, hinge 580 may be replaced with any of a variety of pivotable brackets and/or pivoting members. For example, pivotable brackets could be located at either end of parting line 509 on the outer edges of lower scoring board 507 and upper scoring board 505.

While lower scoring board 507 is in the folded position, the section of lineal scoring grooves 520 on upper scoring board 505 may be divided from the section of lineal scoring grooves 530 on lower scoring board 507 at parting line 509. Additionally, blade guide 573 may be divided at parting line 509. According to various embodiments, one or more catches or latches may selectively maintain lower scoring board 507 in a folded position with respect to upper scoring board 505. For example, one or more magnetic latches may maintain lower scoring board 507 folded beneath upper scoring board 505.

A foldable scoring base 500 with an integrated media trimmer 501 may be transported and stored efficiently by positioning the media trimmer 501 in the storage position, securing the bone folder beneath cutting arm 510, storing an envelope guide within storage slot 560, and folding scoring base 500 in half. According to one embodiment, a handle may be positioned on one side of scoring base 500 to facilitate transportation.

FIG. 6 illustrates an exemplary embodiment of a support lattice 635 for a foldable scoring base 600 with an integrated media trimmer secured by a spring retention assembly 690. Support lattice 635 may be formed as an interstice lattice providing sufficient strength to scoring base 600, while minimizing the overall weight. Foldable scoring base 600 may comprise an upper scoring board 605 and a lower scoring board 607 divided at parting line 609. As illustrated, lower scoring board 607 is in an unfolded position with respect to upper scoring board 605. A hinge 680, or other pivoting member, may enable lower scoring board 607 to fold with respect to scoring board 605. Catches 685 may selectively secure lower scoring board 607 folded against upper scoring board 605. Alternatively, catches 685 may be replaced or supplemented by magnetic catches, latches, and/or clips.

Support lattices 635 may be configured to provide structural support to scoring base 600. The illustrated support lattices 635 merely provide an exemplary embodiment of a support lattice and may be modified or adapted in order to provide adequate support and/or minimize the amount of material used. Legs 625 may be attached to scoring base 600 in various locations to provide adequate support. According to various embodiments, legs 625 may be configured with a height equal to that of the surrounding edges of upper scoring board 605 and lower scoring board 607.

A bone folder, or other scoring implement, may be secured within depression 655 and an envelope guide, or other tool may be secured within storage slot 660. According to various embodiments, an envelope guide may be secured against diagonal brace 667 and prevented from falling out by cross braces 665 and 666.

According to various embodiments, a cutting arm may be secured to upper scoring board 605 via a spring retention assembly 690. The cutting arm may include a pin configured to pass through a bore in upper scoring board 605. A retaining ring may engage the pin and prevent it from being released. As illustrated, a spring may be configured to bias the cutting arm towards scoring base 600. The biasing spring may cause bosses located on the underside of the cutting arm to engage depressions on the topside of the scoring board 600. According to various embodiments, the biasing spring may be conical and configured to nest when compressed.

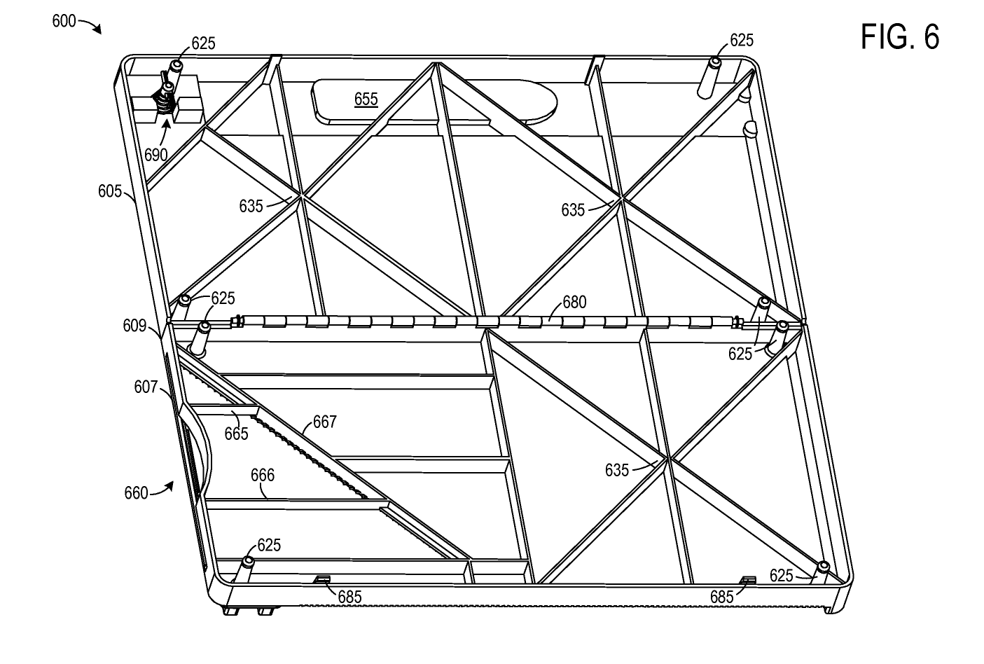

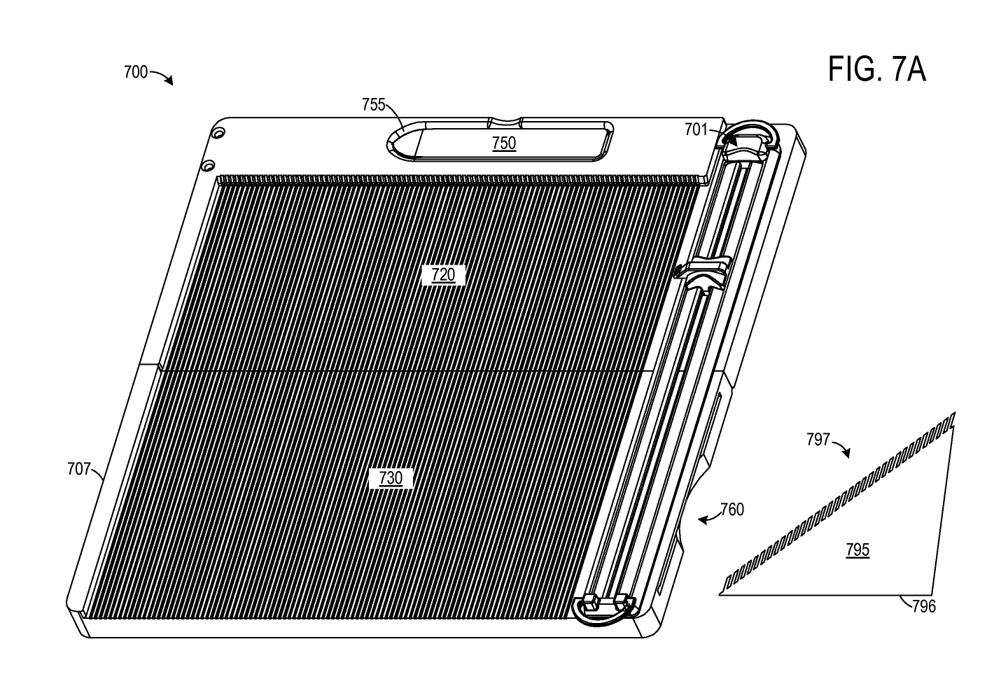

FIG. 7A illustrates an exemplary embodiment of a storage slot 760 located on the lower scoring board 707 of a foldable scoring base 700 with an integrated media trimmer 701. According to various embodiments, storage slot 760 may be configured to receive a triangular envelope guide 795. As illustrated, envelope guide 795 may be configured as a right triangle with a notched hypotenuse 797. According to various embodiments, envelope guide 795 may be used in conjunction with lineal scoring grooves 720 and 730 to create envelopes.

According to one embodiment, the right angle corner 796 of envelope guide 795 may be placed in the top left corner of lineal scoring grooves 720. Media trimmer 701 may be used to trim a medium, such as paper, to the correct dimensions. A scoring implement, such as bone folder 750 stored in depression 755, may be used to score the medium in the appropriate locations to form an envelope. According to various embodiments, with envelope guide 795 placed in the top left corner of lineal scoring grooves 720, notched hypotenuse 797 of envelope guide 795 indicates which grooves bone folder 750 should trace for a particular envelope size and/or style.

FIG. 7B illustrates an exemplary embodiment of the backside of a storage slot 760 within the support lattice 735 of a foldable scoring base 700. Envelope guide 795 may be configured to slidably enter storage slot 760. Hypotenuse 797 of envelope guide 795 may be configured to rest against diagonal support 767. Cross supports 765 and 766 may prevent envelope guide 795 from falling out of the bottom of lower scoring board 707. Storage slot 760 may be adapted to receive and store any of a wide variety of tools such as a ruler, clamp, magnet, blade sharpener, extra blade, and/or scissors. Additionally, one or more storage slots may be located within upper scoring board 705 and/or lower scoring board 707.

Upper scoring board 705 may include a depression 755 configured to receive a scoring implement, such as a bone folder. A hinge 780 may be configured to enable lower scoring board 707 to fold with respect to upper scoring board 705 along parting line 709. According to various embodiments, hinge 780 may be configured to provide a zero/zero parting line 709. The components of hinge 780 may be molded directly into upper scoring board 705 and lower scoring board 707.

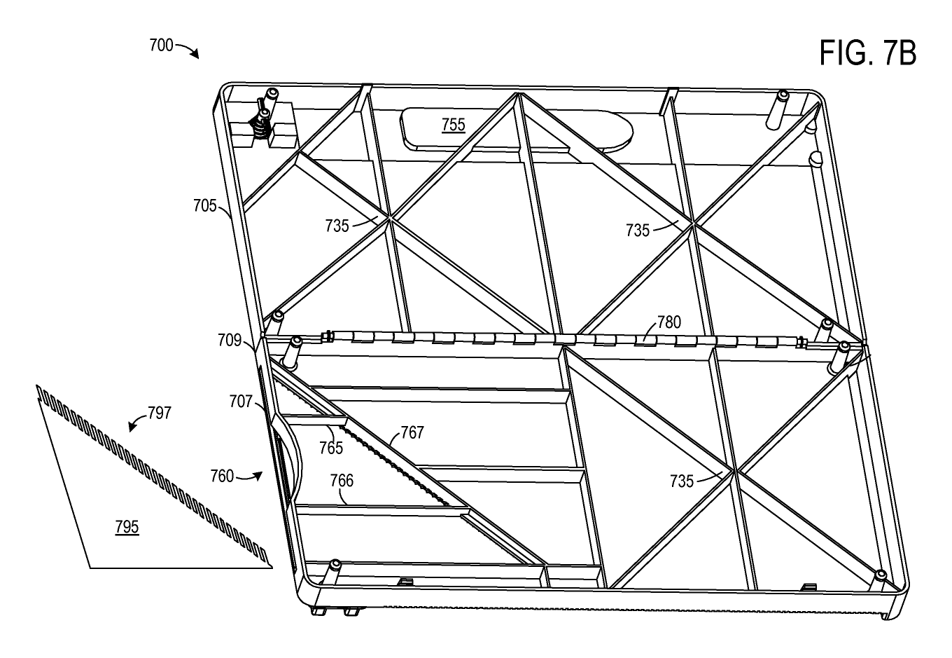

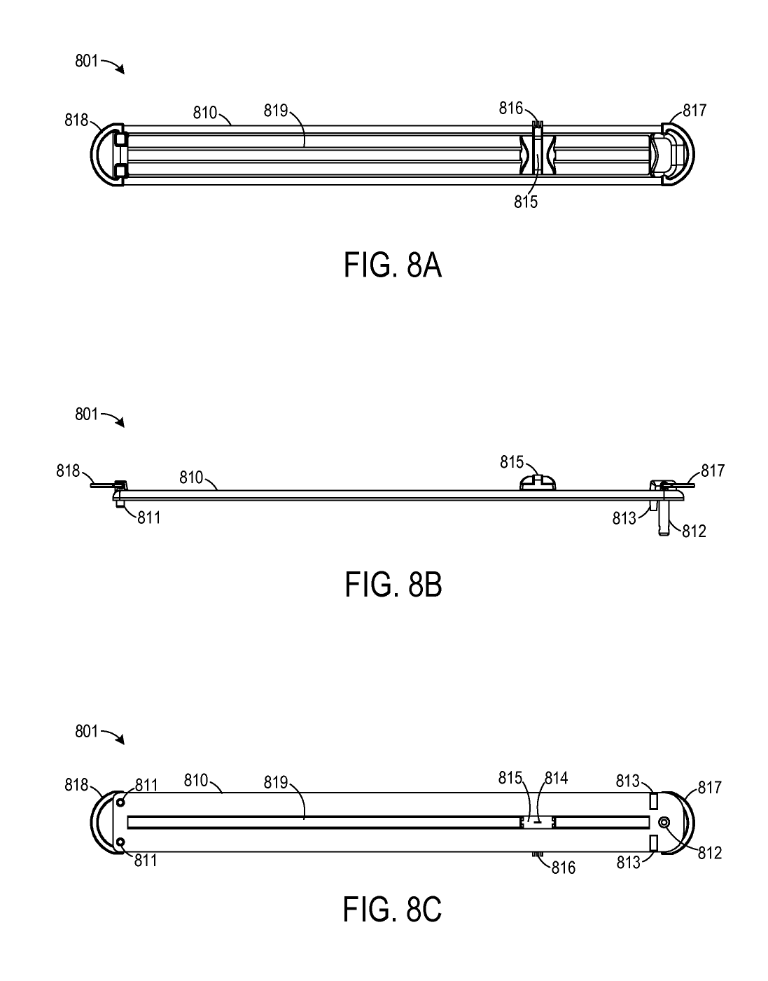

FIG. 8A depicts an exemplary top view of a media trimmer 801. According to various embodiments, media trimmer 801 may be configured as a rotary trimmer, a sliding trimmer, or a guillotine trimmer. As illustrated in FIGS. 8A-8C, media trimmer 801 is configured as a sliding trimmer and includes a blade holder 815 slidably coupled to a cutting arm 810. Blade holder 815 may be configured to secure a wide variety of cutting blades and/or scoring blades. According to various embodiments, media trimmer 801 may be configured to cut, score, and/or trim any of a wide variety of media, including paper, cloth, corkboard, leather, plastics, metal, foil, canvas, cardstock, cardboard, acetate, drafting film, illustration board, black core artist mat board, laminates, and/or tissue paper.

Blade holder 815 may be slidably coupled to cutting arm 810 and configured to slide along a blade tract 819. Blade holder 815 may be configured with a blade marker 816 indicating the location of the blade secured by blade holder 815. According to various embodiments, blade marker 816 may be in the form of a logo. For example, the letter M is used in FIG. 8A with the lower point of the M used to indicate the location of the blade.

Additionally, media trimmer 801 may include an upper ring 817 and a lower ring 818 on the two ends of cutting arm 810. According to various embodiments, an operator may utilize upper and lower rings 817 and 818 to raise cutting arm 810 relative to a scoring base in order to unlock and pivot cutting arm 810. Accordingly, any of a wide variety of alternative features that provide a suitable gripping surface for an operator to manipulate cutting arm 810 could be used in place of upper and lower rings 817 and 818.

FIG. 8B depicts an exemplary side view of media trimmer 801, including cutting arm 810 and blade holder 815. Upper ring 817 may be secured to the top end of cutting arm 810. Additionally, the top end of cutting arm 810 may include bosses 813 and locking pin 812. According to various embodiments, locking pin 812 may be configured to pass through a bore in a scoring board and secured by a ring. As previously described, a conical spring may be used to bias cutting arm 810 against the face of the scoring board. The bottom end of cutting arm 810 may include bosses 811 and a lower ring 818. According to various embodiments, the previously described biasing spring may cause bosses 811 and 813 to engage depressions located on the face of a scoring board in order to secure cutting arm 810 relative to the scoring board.

FIG. 8C depicts an exemplary bottom view of media trimmer 801 including cutting arm 810 and blade holder 815 securing a fixed-blade 814. Blade holder 815 may be slidably connected to cutting arm 810 and include a blade marker 816 in the form of an M. According to various embodiments, blade holder 815 may slide along blade tract 819 as fixed-blade 814 cuts, trims, and/or scores a medium such as paper. Bosses 813 and locking pin 812 may be located on the top end of cutting arm 810 near an upper ring 817. Cutting arm 810 may also include a lower ring 818 and bosses 811 near the bottom end.

According to various alternative embodiments, media trimmer 801 may include a cutting arm 810 and blade holder 815 configured to utilize a rotary blade. According to such embodiments, the rotary blade may be interchangeable with various styles and types of rotary blades. Additionally, blade holder 815 may be configured to self-sharpen a secured blade alone or in combination with a blade guide formed in a scoring base.

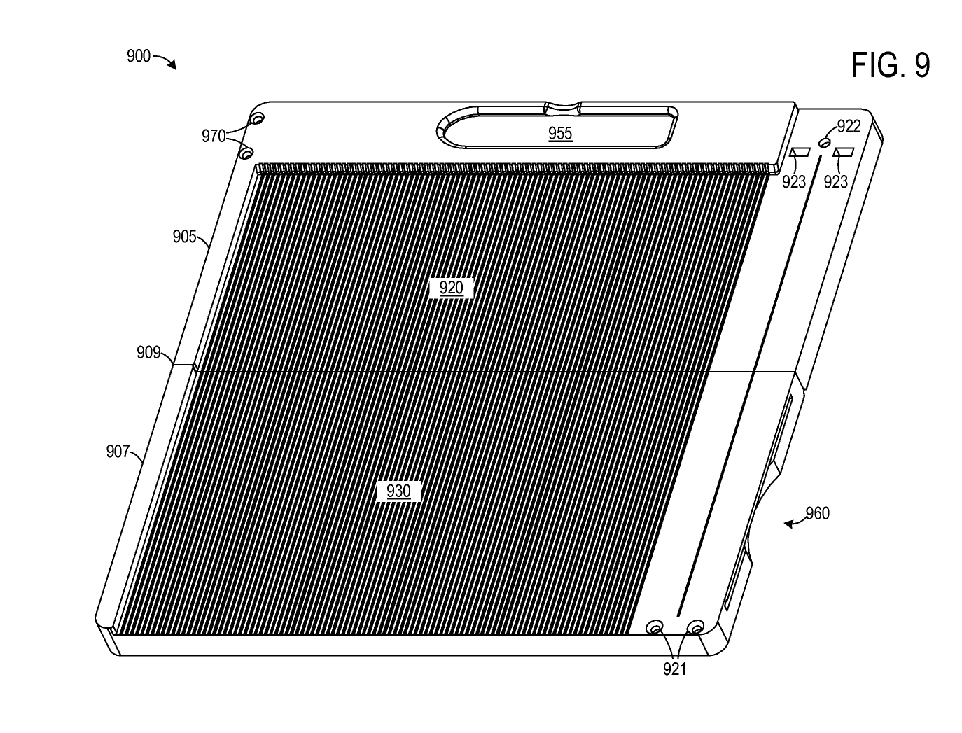

FIG. 9 illustrates an exemplary embodiment of a foldable scoring base 900, including a bone folder depression 955 and a storage slot 960. According to various embodiments, scoring base 900 may be configured to receive a media trimmer via thru-bore 922. Bosses on an underside of the media trimmer may be configured to engage depressions 923 and 921 when the media trimmer is in a cutting position. The media trimmer may be pivoted about thru-bore 922 to a storage position. While in a storage position, the bosses on the bottom end of the media trimmer may be configured to engage depressions 970.

As illustrated, scoring base 900 may comprise an upper scoring board 905 and a lower scoring board 907 divided at a parting line 909. According to various embodiments, the gap separating lower scoring board 907 from upper scoring board 905 at parting line 909 may be minimal or non-existent. Upper scoring board 905 may include a section of lineal scoring grooves 920. Lower scoring board 907 may include a section of lineal scoring grooves 930, aligned with respect to lineal scoring grooves 920. According to the illustrated embodiments, lineal scoring grooves 920 and 930 are aligned with respect to one another and perpendicular to parting line 909. According to one alternative embodiment, lineal scoring grooves 920 and 930 are aligned with respect to one another and parallel to parting line 909.

Lower scoring board 907 may be rotatably coupled to upper scoring board 905 via one or more pivot members, such as a hinge or pivotable fastener. For example, an elongated hinge may remain hidden beneath parting line 909, while lower scoring board 907 is in an unfolded position with respect to upper scoring board 905. According to various embodiments, while lower scoring board 907 is in the unfolded position with respect to upper scoring board 905, lineal scoring grooves 930 on lower scoring board 907 may be seamlessly aligned with lineal scoring grooves 920 on upper scoring board 905.

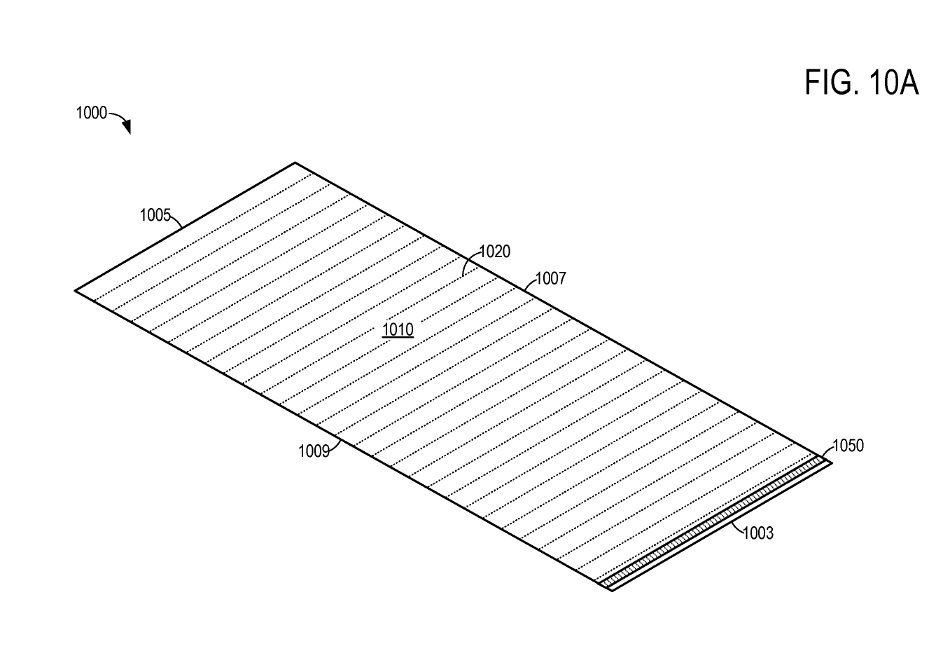

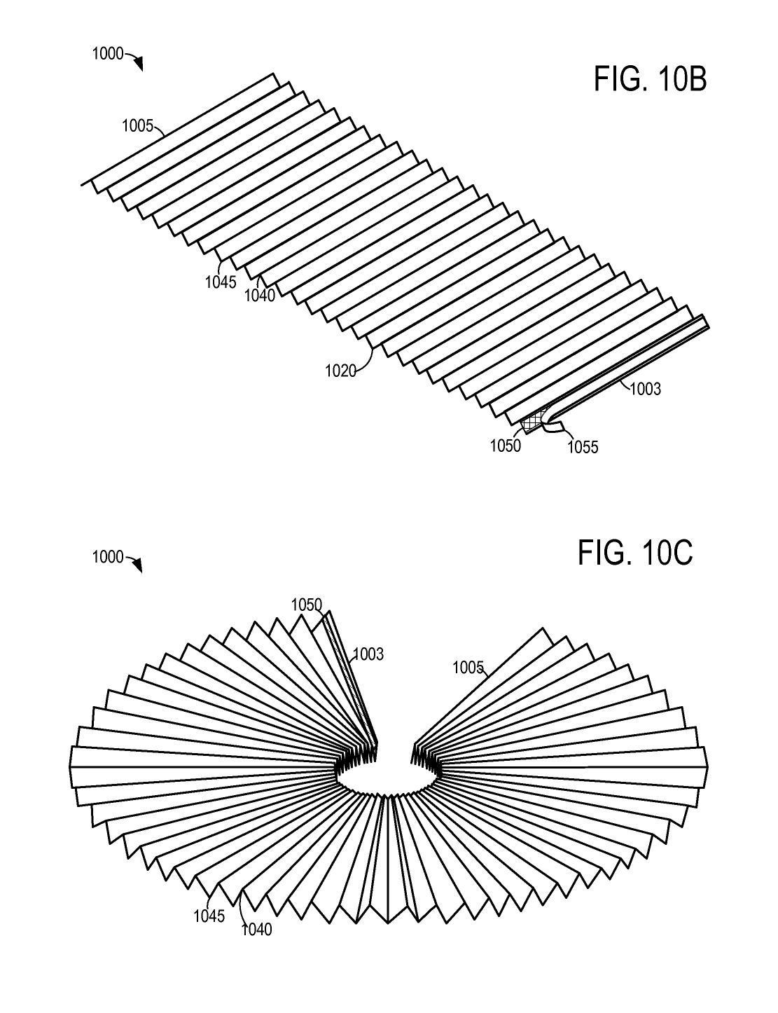

FIGS. 10A-100 illustrate certain steps that may be taken by a user of a foldable scoring base in order to form a rosette. FIG. 10A illustrates one embodiment of a scored rosette strip 1000 with a scored side 1010 facing up. The scored rosette strip 1000 includes scored grooves 1020 evenly spaced between a first end 1003 and a second end 1005. Scored grooves 1020 run between a first side 1007 and a second side 1009. Scored grooves may be formed using a scoring base, as described herein, and a scoring implement. According to various embodiments, the scored grooves 1020 may be spaced unevenly or according to a pattern defined by the lineal scoring grooves in the scoring base. A user may place an adhesive 1050 on first end 1003, which may be configured to join first end 1003 and second end 1005 in order to form a rosette (as described below). According to an alternative embodiment, both first end 1003 and second end 1005 may include an adhesive 1050. Adhesive strip 1050 may include peel-away covering 1055.

Scored rosette strip 1000 may be made of paper, cardstock, construction paper, papier-mâché, and/or other types of paper or suitable materials for forming a rosette. Additionally, scored rosette strip 1000 may be configured with various colors, designs, patterns, sizes, groove spacing, and/or thicknesses. The strips between scored grooves 1020 may include different colors, designs, patterns, sizes and different fold sizes. The strips can be selected to have some similar traits and some dissimilar traits. For example, all strips can be varying shades of the same color, or varying colors within a complementary color family. The number of, the depth of, the scoring pattern of, and the distance between scored grooves 1020 may be selected to provide a desired rosette configuration.

As illustrated in FIG. 10B, a user may fold rosette strip 1000 along each of scored grooves 1020 to form an accordion configuration. The length and width of rosette strip 1000 may be configured by a user to provide a rosette of a specific diameter. Creating scored grooves 1020 using a scoring base may increase the speed at which a user may fold rosette strip 1000, because the user may more quickly fold straight lines once the lines have been scored. As illustrated, rosette strip 1000 is folded numerous times to form a series of peaks 1040 and valleys 1045 extending across the width of scored rosette strip 1000. The height and depth of peaks 1040 and valleys 1045 may be configured as desired for a specific application. According to various embodiments, scored grooves allow the folding of scored rosette strip 1000 to be performed quickly, simply, and reliably without the need to manually measure the separation between each fold.

FIG. 10C illustrates the folded and scored rosette strip of FIG. 10B with a first end partially encircled towards a second end. As illustrated in FIG. 10C, a user may encircle a first end 1003 toward a second end 1005 within the same plane as the folded rosette strip 1000 in order to form a rosette. Adhesive strip 1050 may be used to secure first end 1003 and second end 1005.

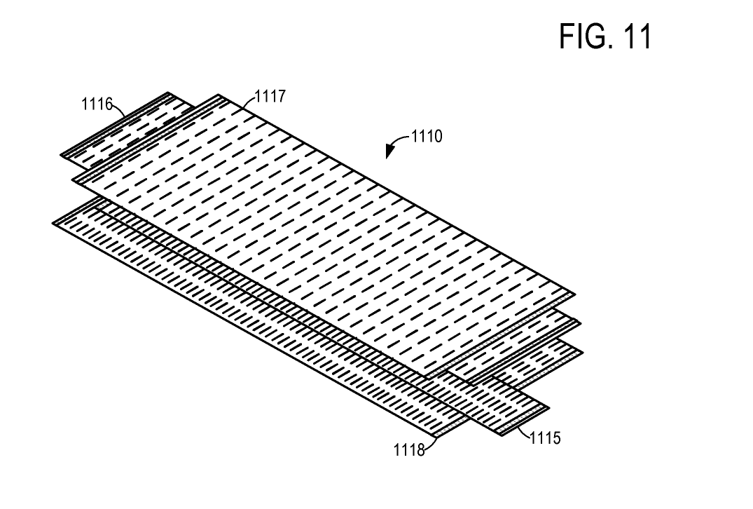

FIG. 11 illustrates a plurality of scored rosette strips 1115, 1116, 1117, and 1118 of varying sizes. Each of scored rosette strips 1115, 1116, 1117, and 1118 may be used to create a rosette of a different size and appearance. Rosette strips 1115-1118 illustrate that scored rosette strips may be created using a foldable scoring board, as described herein, in a wide variety of lengths, widths, scored groove patterns, materials, and/or other characteristics.

The above description provides numerous specific details for a thorough understanding of the embodiments described herein. One or more of the specific details may be omitted, or other methods, components, or materials may be used. In some cases, operations are not shown or described in detail.

While specific embodiments and applications of the disclosure have been illustrated and described, it is to be understood that the disclosure is not limited to the precise configuration and components disclosed herein. Various modifications, changes, and variations apparent to those of skill in the art may be made in the arrangement, operation, and details of the methods and systems of the disclosure without departing from the spirit and scope of the disclosure.

What is claimed:

1. A foldable scoring base, comprising:
an upper scoring board configured with a first section of lineal scoring grooves;
a lower scoring board configured with a second section of lineal scoring grooves aligned with respect to the first section of lineal scoring grooves;
a pivot member connecting the lower scoring board to the upper scoring board, the pivot member configured such that the lower scoring board may be rotated from a folded position to an unfolded position with respect to the upper scoring board;
a cutting arm secured at a first end to the upper scoring board near an edge opposite a parting line between the upper scoring board and the lower scoring board.

2. The foldable scoring base of claim 1, wherein the pivot member comprises a hinge.

3. The foldable scoring base of claim 1, wherein the cutting arm is one of a rotary trimmer, a guillotine trimmer, and a sliding trimmer.

4. The foldable scoring base of claim 1, further comprising a blade holder slidably coupled to the cutting arm, the blade holder configured to secure one of a rotating blade and a fixed-blade.

5. The foldable scoring base of claim 1, wherein the first and second sections of lineal scoring grooves are aligned perpendicular with respect to the parting line between the upper scoring board and the lower scoring board.

6. The foldable scoring base of claim 1, wherein the upper scoring board further comprises a depression configured to receive a scoring implement.

7. The foldable scoring base of claim 6, wherein the scoring implement comprises a bone folder.

8. The foldable scoring base of claim 1, wherein one of the lower scoring board and the upper scoring board comprises a slot configured to receive an envelope guide.

9. The foldable scoring base of claim 1, further comprising a magnetic catch configured to selectively maintain the lower scoring board in the folded position with respect to the upper scoring board.

10. The foldable scoring base of claim 1, wherein the pivot member is secured to the upper scoring board with a spring retention assembly.

11. The foldable scoring base of claim 1, wherein the pivot member is moveable from a first position in which the pivot member is disposed approximately perpendicular to the first section of lineal grooves and a second position in which the pivot member is disposed approximately parallel to the first section of lineal grooves.

12. The foldable scoring base of claim 11, further comprising a projection disposed near a second end of the pivot member in the folded configuration and wherein the pivot member comprises a depression having a complimentary shape to the projection.

13. The foldable scoring base of claim 1, further comprising an interstice lattice.

14. A foldable scoring base, comprising:
an upper scoring board configured with a first section of lineal scoring grooves;
a lower scoring board configured with a second section of lineal scoring grooves aligned with respect to the first section of lineal scoring grooves;
a pivot member connecting the lower scoring board to the upper scoring board, the pivot member configured such that the lower scoring board may be rotated from a folded position to an unfolded position with respect to the upper scoring board;
a cutting arm comprising:
a first end rotatably secured to the upper scoring board, such that the cutting arm can be pivoted about the first end; and
a second end configured to rotate from a storage position, in which the second end is coupled to the upper scoring board, to a cutting position, in which the second end is releaseably coupled to the lower scoring board.

15. The foldable scoring base of claim 14, wherein the pivot member comprises a hinge.

16. The foldable scoring base of claim 14, wherein the cutting arm comprises one of a rotary trimmer, a guillotine trimmer, and a sliding trimmer.

17. The foldable scoring base of claim 14, wherein the cutting arm is rotatably secured to the upper scoring board via a spring retention assembly.

18. The foldable scoring base of claim 14, wherein the first and second sections of lineal scoring grooves are aligned approximately perpendicular with respect to a parting line between the upper scoring board and the lower scoring board.

19. The foldable scoring base of claim 14, wherein the upper scoring board further comprises a depression configured to receive a scoring implement; and
wherein the depression is positioned such that the cutting arm secures the scoring implement within the depression when the cutting arm is in the storage position.

20. The foldable scoring base of claim 19, wherein the scoring implement is a bone folder.

21. The foldable scoring base of claim 14, wherein one of the lower scoring board and the upper scoring board includes a slot configured to receive an envelope guide.

22. The foldable scoring base of claim 10, further comprising a magnetic catch configured to selectively maintain the lower scoring board in a folded position with respect to the upper scoring board.

23. A foldable scoring base, comprising:
an upper scoring board configured with a first section of lineal scoring grooves;
a lower scoring board configured with a second section of lineal scoring grooves aligned with respect to the first section of lineal scoring grooves;
a hinge connecting the lower scoring board to the upper scoring board, such that the lower scoring board may be rotated from a folded position to an unfolded position with respect to the upper scoring board;
a catch configured to selectively maintain the lower scoring board in a folded position with respect to the upper scoring board;
a cutting arm comprising:
a first end rotatably secured to the upper scoring board, such that the cutting arm can be pivoted about the first end;
a second end configured to rotate from a storage position, in which the second end is coupled to the upper scoring board, to a cutting position, in which the second end is releaseably coupled to the lower scoring board;
a blade holder slidably coupled between the first and second ends of the cutting arm configured to secure a blade; and
a depression configured to receive a scoring implement, the depression positioned such that the cutting arm secures the scoring implement within the depression when the cutting arm is in the storage position.
